(19) United States
(12) Patent Application Publication
(10) Pub. No.: US 2009/0327966 A1
(43) Pub. Date: Dec. 31, 2009

(54) ENTERING AN OBJECT INTO A MOBILE TERMINAL

(75) Inventor: Timo Paajanen, Lielahti (FI)

Correspondence Address: Perman & Green, LLP, 99 Hawley Lane, Stratford, CT, 06614, US

(73) Assignee: NOKIA CORPORATION, Espoo (FI)

(21) Appl. No.: 12/164,733

(22) Filed: Jun. 30, 2008

(51) Int. Cl. G06F 3/048

(52) U.S. Cl. 715/835

(57) ABSTRACT

A mobile terminal for entering an object from a set of objects into the mobile terminal. The mobile terminal can include: a display configured to display, in a first display state, a display area that is divided into a plurality of individually selectable fields that are arranged in a first matrix pattern, and further configured to display, within each of the individually selectable fields of only one of the rows or columns of the first matrix pattern, a plurality of objects such that all the objects together form a second matrix pattern, wherein each of the individually selectable fields represent a particular object having a position within the second matrix pattern which corresponds to the position of the individually selectable field within the first matrix pattern; and an input device configured to determine a position of a pointer with respect to the plurality of individually selectable fields, wherein the pointer is moveable to either of the individually selectable fields for selection of the object represented by the selected field. A corresponding method, computer program product and user interface are also presented.

### TECHNICAL FIELD

The aspects of the disclosed embodiments relate to the field of mobile terminals, and more particularly to entering of objects, such as graphical characters, into such mobile terminals.

### BACKGROUND

Mobile terminals, e.g. mobile (cellular) telephones, for mobile telecommunications systems like GSM, UMTS, D-AMPS and CDMA2000 have been used for many years. In the older days, mobile terminals were used almost exclusively for voice communication with other mobile terminals or stationary telephones. Gradually, the use of mobile terminals has been broadened to include not just voice communication, but also various other services and applications such as www/wap browsing, video telephony, electronic messaging (e.g. SMS, MMS, email, instant messaging), digital image or video recording, FM radio, music playback, electronic games, calendar/organizer/time planner, word processing, etc.

The increasing number of services and applications has brought many challenges to users who want to efficiently enter data into the memory of these mobile terminals. At the same time, there has been a trend towards ever-increasing reduction of the size of these mobile terminals. This reduction of size has led to the concern that data entry into the mobile terminals may be difficult.

Mobile terminals are therefore provided with various systems for facilitating input of objects, such as graphical characters. One system commonly used with mobile telephones is to let each numerical key of a keypad of the mobile telephone represent up to four characters, which enables the user to input a certain character by depressing the appropriate key a certain number of times corresponding to the desired character. Other mobile terminals provide, on a touch-sensitive screen, a virtual alphanumeric keyboard for character input. The user can then select from virtual alphanumeric keyboard, often using a stylus, which character to input.

One related art approach to provide an object entry system is to display on a display screen of a mobile terminal a main set of individually selectable objects, each of which represents a subset of individually selectable objects. The user selects, in a first step, a subset of objects from the main set of selectable objects and then, in a second step, selects an individual object from the selected subset of objects. This may allow for an efficient system for entering objects from a large set of objects when the display screen space is relatively limited, such as on a mobile telephone, a Personal Digital Assistant (PDA), a media player, etc. A system of this type is disclosed in the international patent application PCT/IB03/01710 (published under WO 03/098417), to Koninlijke Philips Electronics N.V.

### SUMMARY

In view of the above, it would be desirable to achieve a novel and alternative method for entering objects, such as graphical characters, into a mobile terminal.

It would also be desirable to achieve a novel and alternative computer program product for entering objects, such as graphical characters, into a mobile terminal.

It would also be desirable to achieve a novel and alternative mobile terminal for entering objects, such as graphical characters, into the mobile terminal.

It would also be desirable to achieve a novel and alternative user interface for entering objects, such as graphical characters, into a mobile terminal.

According to a first aspect of the disclosed embodiments there is provided a method for entering an object from a set of objects into an mobile terminal, the method comprising: displaying, on a display of the mobile terminal, a display area that is divided into a plurality of individually selectable fields that are arranged in a first matrix pattern having rows and columns; presenting in a first display state, within each of the individually selectable fields of only one of the rows or columns of the first matrix pattern, a plurality of objects such that all the objects together form a second matrix pattern having rows and columns, wherein each of the individually selectable fields represent a particular object having a position within the second matrix pattern which corresponds to the position of the individually selectable field within the first matrix pattern; and moving a pointer to either of the individually selectable fields for thereby selecting the object represented by the selected field.

The method may comprise performing an entry into the mobile terminal of the selected object.

The first matrix pattern may be a m×n matrix with m number of rows and n number columns and, likewise, the second matrix pattern may be a m×n matrix with m number of rows and n number columns, and wherein m and n are integers. For example, m may equal n. Alternatively, m is different from n.

The object may be a graphical character.

The object may be associated with software code and the method may further comprise invoking the software code of the selected object associated with the software code.

Said invoking software code may, e.g., involve invoking software code for allowing movement to a second display state, which is different from the first display state.

In one embodiment, the object may be a subset of individual objects and the step of moving may comprise moving the pointer to either of the individually selectable fields for thereby selecting the subset of individual objects represented by the selected field, and the method may further comprise, in response thereto: presenting in a second display state, within each of the individually selectable fields of said only one of said rows or columns of the first matrix pattern, an individual object such that all the individual objects of the selected subset of individual objects together form, within said only one of said rows or columns of the first matrix pattern, a row or column corresponding to the row or column of the selected subset of individual objects, wherein each of the individually selectable fields of said only one of said rows or columns of the first matrix pattern represent a particular individual object having a position within the row or column of the selected subset of individual objects which corresponds to the position of the individually selectable field within the said only one of said rows or columns of the first matrix pattern; and moving a pointer to either of the individually selectable fields of said only one of said rows or columns of the first matrix pattern for selection of the individual object represented by the selected field.

The method may further comprise performing an entry into the mobile terminal of the selected individual object.

The first matrix pattern may be a m×n matrix with m number of rows and n number columns and, likewise, the second matrix pattern may be a m×n matrix with m number of rows and n number columns, and wherein m and n are integers. For example, m may equal n. Alternatively, m is different from n.

The set of individual objects may be a set of graphical characters arranged in a row or column.

An individual object may be an individual graphical character.

An individual object may be associated with software code and the method may further comprise invoking the software code of the selected individual object associated with the software code.

Said invoking software code may involve invoking software code for allowing movement to a third display state, which is different from the first and second display states.

According to a second aspect of the disclosed embodiments there is provided a computer program product comprising software instructions that, when executed in a controller of a mobile terminal, performs the method according to the above-mentioned first aspect of the invention.

According to a third aspect of the disclosed embodiments there is provided a mobile terminal for entering an object from a set of objects into the mobile terminal, comprising: means for displaying, on a display of the mobile terminal, a display area that is divided into a plurality of individually selectable fields that are arranged in a first matrix pattern having rows and columns; means for presenting in a first display state, within each of the individually selectable fields of only one of the rows or columns of the first matrix pattern, a plurality of objects such that all the objects together form a second matrix pattern having rows and columns, wherein each of the individually selectable fields represent a particular object having a position within the second matrix pattern which corresponds to the position of the individually selectable field within the first matrix pattern; and means for moving a pointer to either of the individually selectable fields for selection of the object represented by the selected field.

The mobile terminal may comprise means for performing an entry into the mobile terminal of the selected object.

The first matrix pattern may be a m×n matrix with m number of rows and n number columns and, likewise, the second matrix pattern may be a m×n matrix with m number of rows and n number columns, and wherein m and n are integers. For example, m may equal n. Alternatively, m is different from n.

The object may be a graphical character.

The object may be associated with software code and the mobile terminal may comprise means for invoking the software code of the selected object associated with the software code.

Said means for invoking the software code may be operative to invoke said invoking software code for allowing movement to a second display state, which is different from the first display state.

According to a fourth aspect of the disclosed embodiments there is provided a mobile terminal for entering an object from a set of objects into the mobile terminal, comprising: means for displaying, on a display of the mobile terminal, a display area that is divided into a plurality of individually selectable fields that are arranged in a first matrix pattern having rows and columns; means for presenting in a first display state, within each of the individually selectable fields of only one of the rows or columns of the first matrix pattern, a plurality of subsets of objects such that all the subsets of objects together form a second matrix pattern having rows and columns, wherein each of the individually selectable fields represent a particular subset of objects having a position within the second matrix pattern which corresponds to the position of the individually selectable field within the first matrix pattern; means for moving a pointer to either of the individually selectable fields for selection of the subset of objects represented by the selected field; means for presenting in response thereto in a second display state, within each of the individually selectable fields of said only one of said rows or columns of the first matrix pattern, an individual object such that all the individual objects of the selected subset of objects together form, within said only one of said rows or columns of the first matrix pattern, a row or column corresponding to the row or column of the selected subset of objects, wherein each of the individually selectable fields of said only one of said rows or columns of the first matrix pattern represents a particular individual object having a position within the row or column of the selected subset of objects which corresponds to the position of the individually selectable fields within the said only one of said rows or columns of the first matrix pattern; and means for moving a pointer to either of the individually selectable fields of said only one of said rows or columns of the first matrix pattern for selection of the individual object represented by the selected field.

The mobile terminal may comprise means for performing an entry into the mobile terminal of the selected individual object.

The first matrix pattern may be a m×n matrix with m number of rows and n number columns and, likewise, the second matrix pattern may be a m×n matrix with m number of rows and n number columns, and wherein m and n are integers. For example, m may equal n. Alternatively, m is different from n.

The set of individual objects may be a set of graphical characters arranged in a row or column.

An individual object may be an individual graphical character.

An individual object may be associated with software code and the mobile terminal may further comprise means for invoking the software code of the selected individual object associated with the software code.

Said means for invoking the software code may be operative to invoke said invoking software code for allowing movement to a third display state, which is different from the first and second display states.

According to a fifth aspect of the disclosed embodiments there is provided a mobile terminal for entering an object from a set of objects into the mobile terminal, comprising: means for displaying, on a display of the mobile terminal, a display area that is divided into a plurality of individually selectable fields that are arranged in a first matrix pattern having rows and columns; means for presenting in a first display state, within each of the individually selectable fields of only one of the rows or columns of the first matrix pattern, a plurality of objects such that all the objects together form a second matrix pattern having rows and columns, wherein each of the individually selectable fields represent a particular object having a position within the second matrix pattern which corresponds to the position of the individually selectable field within the first matrix pattern; and means for moving a pointer to either of the individually selectable fields for selection of the object represented by the selected field; wherein the means for presenting is arranged to present the plurality of objects such that only a minority of the total display area of said display is used for presenting the plurality of objects.

The mobile terminal may comprise means for performing an entry into the mobile terminal of the selected object.

The first matrix pattern may be a m×n matrix with m number of rows and n number columns and, likewise, the second matrix pattern may be a m×n matrix with m number of rows and n number columns, and wherein m and n are integers. For example, m may equal n. Alternatively, m is different from n.

For example, the means for presenting may be arranged to present the plurality of objects such that only 50 percent (or less) of the total display area is used for presenting the plurality of objects. In one embodiment, the first and second matrix patterns may be of an 8×2 dimension, where only 50 percent of the total display area is used for presenting the plurality of objects. In another embodiment, the first and second matrix patterns may be of a 3×3 dimension, where only one third (i.e., approximately 33 percent) of the total display area is used for presenting the plurality of objects. In yet another embodiment, the first and second matrix patterns may be of a 4×4 dimension, where only 25 percent of the total display area is used for presenting the plurality of objects.

The object may be a graphical character.

The object may be associated with software code and the mobile terminal may comprise means for invoking the software code of the selected object associated with the software code.

Said means for invoking the software code may be operative to invoke said invoking software code for allowing movement to a second display state, which is different from the first display state.

According to a sixth aspect of the disclosed embodiments there is been provided a mobile terminal for entering an object from a set of objects into the mobile terminal, comprising: means for displaying, on a display of the mobile terminal, a display area that is divided into a plurality of individually selectable fields that are arranged in a first matrix pattern having rows and columns; means for presenting in a first display state, within each of the individually selectable fields of only one of the rows or columns of the first matrix pattern, a plurality of subset of objects such that all the subsets of objects together form a second matrix pattern having rows and columns, wherein each of the individually selectable fields represent a particular subset of objects having a position within the second matrix pattern which corresponds to the position of the individually selectable field within the first matrix pattern; means for moving a pointer to either of the individually selectable fields for selection of the subset of objects represented by the selected field; means for presenting in response thereto in a second display state, within each of the individually selectable fields of said only one of said rows or columns of the first matrix pattern, an individual object such that all the individual object of the selected subset of objects together form, within said only one of said rows or columns of the first matrix pattern, a row or column corresponding to the row or column of the selected subset of objects, wherein each of the individually selectable fields of said only one of said rows or columns of the first matrix pattern represents a particular individual object having a position within the row or column of the selected subset of objects which corresponds to the position of the individually selectable fields within the said only one of said rows or columns of the first matrix pattern; and means for moving a pointer to either of the individually selectable fields of said only one of said rows or columns of the first matrix pattern for selection of the individual object represented by the selected field; wherein any of or both of the means for presenting is/are arranged to present the plurality of objects and the individual objects, respectively, such that only a minority of the total display area of said display is used for presenting the plurality of objects and the individual objects, respectively.

The mobile terminal may comprise means for performing an entry into the mobile terminal of the selected individual object.

The first matrix pattern may be a m×n matrix with m number of rows and n number columns and, likewise, the second matrix pattern may be a m×n matrix with m number of rows and n number columns, and wherein m and n are integers. For example, m may equal n. Alternatively, m is different from n.

For example, any of or both of the means for presenting may be arranged to present the plurality of objects and individual objects, respectively, such that only 50 percent (or less) of the total display area is used for presenting the plurality of objects and individual objects, respectively. In one embodiment, the first and second matrix patterns may be of an 8×2 dimension where only 50 percent of the total display area is used for presenting the plurality of objects and individual objects, respectively. In another embodiment, the first and second matrix patterns may be of a 3×3 dimension, where only one third (i.e., approximately 33 percent) of the total display area is used for presenting the plurality of objects and individual objects, respectively. In yet another embodiment, the first and second matrix patterns may be of a 4×4 dimension, where only 25 percent of the total display area is used for presenting the plurality of objects and individual objects, respectively.

The set of individual objects may be a set of graphical characters arranged in a row or column.

An individual object may be an individual graphical character.

An individual object may be associated with software code and the mobile terminal may further comprise means for invoking the software code of the selected individual object associated with the software code.

Said means for invoking the software code may be operative to invoke said invoking software code for allowing movement to a third display state, which is different from the first and second display states.

In one embodiment, the means for presenting in a first display state and the means for presenting in a second display state are comprised in one single, thus common, means for presenting.

According to a seventh aspect of the disclosed embodiments there is provided a mobile terminal for entering an object from a set of objects into the mobile terminal, comprising: a display operative to display, in a first display state, a display area that is divided into a plurality of individually selectable fields that are arranged in a first matrix pattern having rows and columns, and further operative to display, within each of the individually selectable fields of only one of the rows or columns of the first matrix pattern, a plurality of objects such that all the objects together form a second matrix pattern having rows and columns, wherein each of the individually selectable fields represent a particular object having a position within the second matrix pattern which corresponds to the position of the individually selectable field within the first matrix pattern; and an input device operative to determine a position of a pointer with respect to the plurality of individually selectable fields, wherein the pointer is moveable to either of the individually selectable fields for selection of the object represented by the selected field.

The input device may be operative to perform an entry into the mobile terminal of the selected object.

The first matrix pattern may be a m×n matrix with m number of rows and n number columns and, likewise, the second matrix pattern may be a m×n matrix with m number of rows and n number columns, and wherein m and n are integers. For example, m may equal n. Alternatively, m is different from n.

The object may be a graphical character.

The object may be associated with software code and a controller of the mobile terminal may be operative to invoke the software code of the selected object associated with the software code.

Said controller of the mobile terminal may be operative to invoke said invoking software code for allowing movement to a second display state, which is different from the first display state.

In one embodiment, the object may be a subset of individual objects, wherein the input device may be further operative to determine a position of a pointer with respect to the plurality of individually selectable fields, for in dependence of the position of the pointer causing the display to display in a second display state, within each of the individually selectable fields of said only one of said rows or columns of the first matrix pattern, an individual object of the selected subset of individual objects such that all the individual objects of the selected subset of individual objects together form, within said only one of said rows or columns of the first matrix pattern, a row or column corresponding to the row or column of the selected subset of individual objects, wherein each of the individually selectable fields of said only one of said rows or columns of the first matrix pattern represents a particular individual object having a position within the row or column of the selected subset of individual objects which corresponds to the position of the individually selectable fields within the said only one of said rows or columns of the first matrix pattern; and wherein the pointer may be further moveable to a either of the individually selectable fields for selection of the individual object represented by the selected field.

The input device may be operative to perform an entry into the mobile terminal of the selected individual object.

The first matrix pattern may be a m×n matrix with m number of rows and n number columns and, likewise, the second matrix pattern may be a m×n matrix with m number of rows and n number columns, and wherein m and n are integers. For example, m may equal n. Alternatively, m is different from n.

The set of individual objects may be a set of graphical characters arranged in a row or column.

An individual object may be an individual graphical character.

An individual object may be associated with software code and a controller of the mobile terminal may be operative to invoke the software code of the selected object associated with the software code.

Said controller of the mobile terminal may be operative to invoke said invoking software code for allowing movement to a third display state, which is different from the first and second display states.

According to a eight aspect of the disclosed embodiments there is provided a user interface for entering an object from a set of objects into a mobile terminal, comprising: a display operative to display, in a first display state, a display area that is divided into a plurality of individually selectable fields that are arranged in a first matrix pattern having rows and columns, and further operative to display, within each of the individually selectable fields of only one of the rows or columns of the first matrix pattern, a plurality of objects such that all the objects together form a second matrix pattern having rows and columns, wherein each of the individually selectable fields represent a particular object having a position within the second matrix pattern which corresponds to the position of the individually selectable field within the first matrix pattern; and an input device operative to determine a position of a pointer with respect to the plurality of individually selectable fields, wherein the pointer is moveable to either of the individually selectable fields for selection of the object represented by the selected field.

The input device may be operative to perform an entry into the mobile terminal of the selected object.

The first matrix pattern may be a m×n matrix with m number of rows and n number columns and, likewise, the second matrix pattern may be a m×n matrix with m number of rows and n number columns, and wherein m and n are integers. For example, m may equal n. Alternatively, m is different from n.

The object may be a graphical character.

The object may be associated with software code and a controller of the mobile terminal, which controller is communicatively coupled to the user interface, may be operative to invoke the software code of the selected object associated with the software code.

Said controller of the mobile terminal may be operative to invoke said invoking software code for allowing movement to a second display state, which is different from the first display state.

According to a ninth aspect of the disclosed embodiments there is provided a user interface for entering an object from a set of objects into a mobile terminal, comprising: a display operative to display, in a first display state, a display area that is divided into a plurality of individually selectable fields that are arranged in a first matrix pattern having rows and columns, and further operative to display, within each of the individually selectable fields of only one of the rows or columns of the first matrix pattern, a plurality of subset of objects such that all the subsets of objects together form a second matrix pattern having rows and columns, wherein each of the individually selectable fields represent a particular subset of objects having a position within the second matrix pattern which corresponds to the position of the individually selectable field within the first matrix pattern; and an input device operative to determine a position of a pointer with respect to the plurality of individually selectable fields, for in dependence of the position of the pointer causing the display to display in a second display state, within each of the individually selectable fields of said only one of said rows or columns of the first matrix pattern, an individual object such that all the individual objects of the selected subset of objects together form, within said only one of said rows or columns of the first matrix pattern, a row or column corresponding to the row or column of the selected subset of objects, wherein each of the individually selectable fields of said only one of said rows or columns of the first matrix pattern represent a particular individual object having a position within the row or column of the selected subset of objects which corresponds to the position of the individually selectable fields within the said only one of said rows or columns of the first matrix pattern; and wherein the pointer is moveable to a either of the individually selectable fields for selection of the subset of objects or individual object represented by the selected field.

The input device may be operative to perform an entry into the mobile terminal of the selected object.

The first matrix pattern may be a m×n matrix with m number of rows and n number columns and, likewise, the second matrix pattern may be a m×n matrix with m number of rows and n number columns, and wherein m and n are integers. For example, m may equal n. Alternatively, m is different from n.

The object may be a graphical character.

The object may be associated with software code and a controller of the mobile terminal, which controller is communicatively coupled to the user interface, may be operative to invoke the software code of the selected object associated with the software code.

Said controller of the mobile terminal may be operative to invoke said invoking software code for allowing movement to a third display state, which is different from the first and second display states.

The different features of the above-mentioned aspects of the invention can be combined in any combination.

Furthermore, the second, third, fourth, fifth, sixth, seventh, eight and ninth aspects of the disclosed embodiments may generally have the same features and advantages as the first aspect

Some of the embodiments provide for a novel and alternative way of entering objects, such as graphical characters, into a mobile terminal. It is an advantage with some embodiments that they provide for improved usage of the available display area of the display of the mobile terminal. Furthermore, it is an advantage with some that they provide a user-friendly and intuitive way of entering objects into the mobile terminal. Moreover, it is an advantage with some embodiments that they allow for enhanced navigation when entering objects into the mobile terminal.

Other features and advantages of the disclosed embodiments will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects of the disclosed embodiments will now be described in more detail, reference being made to the enclosed drawings, in which:

FIG. 1 is a schematic illustration of a cellular telecommunication system, as an example of an environment in which the aspects of the disclosed embodiments may be applied;

FIG. 2 is a schematic front view illustrating a mobile terminal according to an embodiment;

FIG. 3a-f schematically illustrate how an object may be selected according to an embodiment;

FIG. 4 is a schematic front view illustrating a mobile terminal according to an embodiment;

FIG. 5a-h schematically illustrate how an object may be selected according to an embodiment;

FIG. 6 is a flow chart illustrating a method according to an embodiment;

FIG. 7 is a flow chart illustrating a method according to an embodiment;

FIG. 8 is a schematic block diagram representing an internal component, software and protocol structure of an embodiment of the mobile terminal shown in FIGS. 2 and 4.

### DETAILED DESCRIPTION OF EMBODIMENTS

The aspects of the disclosed embodiments will now be described more fully hereinafter with reference to the accompanying drawings, in which certain embodiments are shown. This aspect of the disclosed embodiments may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

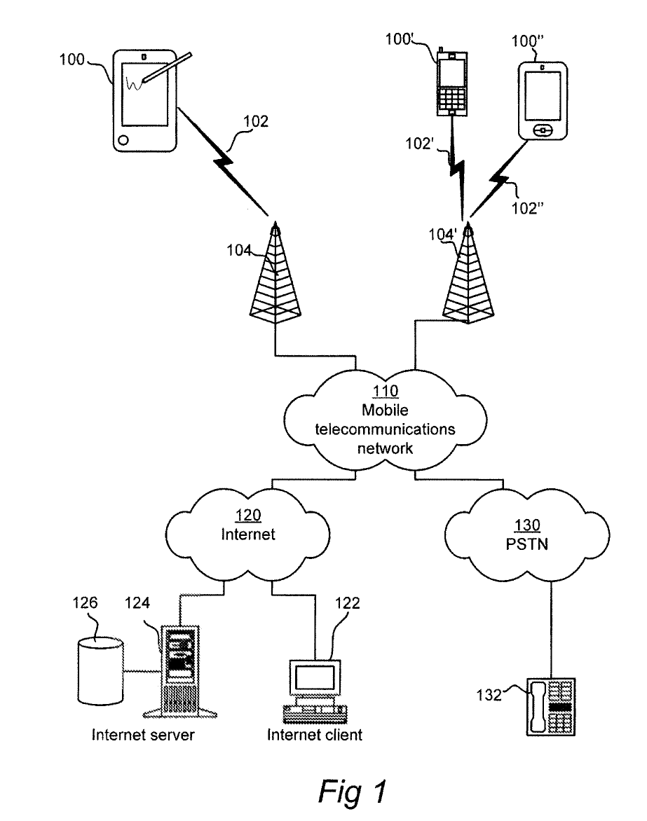

A telecommunications system in which the present invention may be applied will first be described with reference to FIG. 1. Thereafter, the particulars of the mobile terminal and methods according to certain embodiments of the invention will be described with reference to the remaining FIGS.

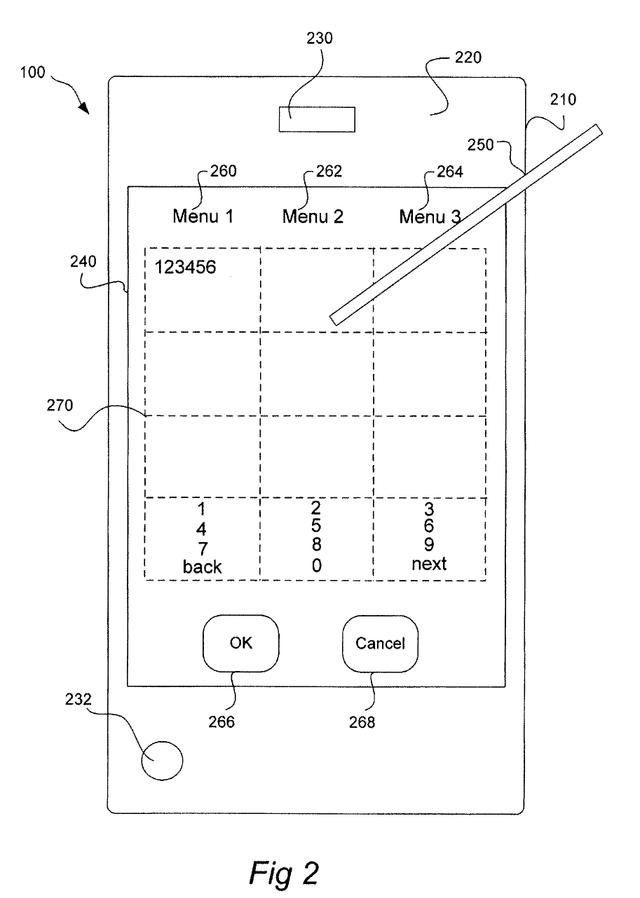

In the telecommunications system of FIG. 1, various telecommunications services such as voice calls, data calls, facsimile transmissions, music transmissions, still image transmissions, video transmissions, electronic message transmissions and electronic commerce may be performed by way of a portable communication apparatus or mobile terminal 100. The mobile terminal 100 may be connected to a mobile telecommunications network 110 through an RF link 102 via a base station 104, as is well known in the art. The mobile telecommunications network 110 may be any commercially available mobile telecommunications system, for example GSM, UMTS, D-AMPS or CDMA2000. In this example, the mobile terminal 100 is illustrated as a mobile (cellular) telephone but may alternatively be another type of portable device, such as a portable/personal digital assistant (PDA) or a communicator. As will be explained in more detail with reference to FIG. 2, the mobile terminal 100 may have a stylus-operated user interface including a touch-sensitive display screen onto which a user may enter handwritten information as well as operational commands by way of a stylus, pen, finger or similar tool. In the illustrated example, the mobile terminal 100 may be used for speech communication with users of other devices. Hence, speech may be communicated with a user of a stationary telephone 132 through a public switched telephone network (PSTN) 130 and the mobile telecommunications network 110, and with a user of another mobile terminal 100′, 100″ which is connected to the mobile telecommunications network 110 over a wireless communication link 102′, 102″. The mobile telecommunications network 110 may be operatively connected to a wide area network 120, which may be Internet or a part thereof. Thus, the mobile terminal 100 may access a computer 122 connected to the wide area network 120 in accordance with specified protocols (such as TCP, IP and HTTP) and appropriate application software (such as a WAP or WWW browser, an email or SMS application, etc) in the mobile terminal 100. Furthermore, the mobile terminal 100 may access a server 124 having a data storage 126. It should be appreciated that the system illustrated in FIG. 1 serves exemplifying purposes only.

FIG. 2 illustrates an exemplary embodiment of the mobile terminal 100 of FIG. 1 in more detail. For ease of understanding, the exemplary embodiment will be described with reference to a mobile terminal 100 comprising a touch-sensitive display 240. A stylus 250 and/or a user's finger (not shown) is used for providing user input to the mobile terminal 100 by performing operations on the touch-sensitive display 240 of the mobile terminal 100. It is, however, to be noted that the present invention is not limited to mobile terminals 100 having a stylus-operated user interface as is illustrated in FIG. 2. Other embodiments of the invention could e.g. be applied in mobile terminals 100′, 100″ (see FIG. 1) having joystick-operated user interfaces or with keypad-operated user interfaces for entering information as well as operational commands.

The mobile terminal 100 comprises a housing 210. A front surface 220 of the mobile terminal 100 comprises a touch-sensitive display 240. As is well known in the art, the touch-sensitive display constitutes a user interface that is not only an output device for presenting visual information to the user, but also an input device. In more particular, by pointing, tapping or dragging the stylus 250 on the touch-sensitive display the user may use the stylus 250 to control the user interface of the mobile terminal. As can be seen, the display 240 may comprise a display area denoted 270. This will be further described in more detail below.

In addition, the front surface 220 may comprise a speaker 230 and a microphone 232. Furthermore, the display 240 may optionally additionally include different menus 260, 262, 264 and their respective menu options and one or several selectable elements such as icons or click buttons 266, 268, etc.

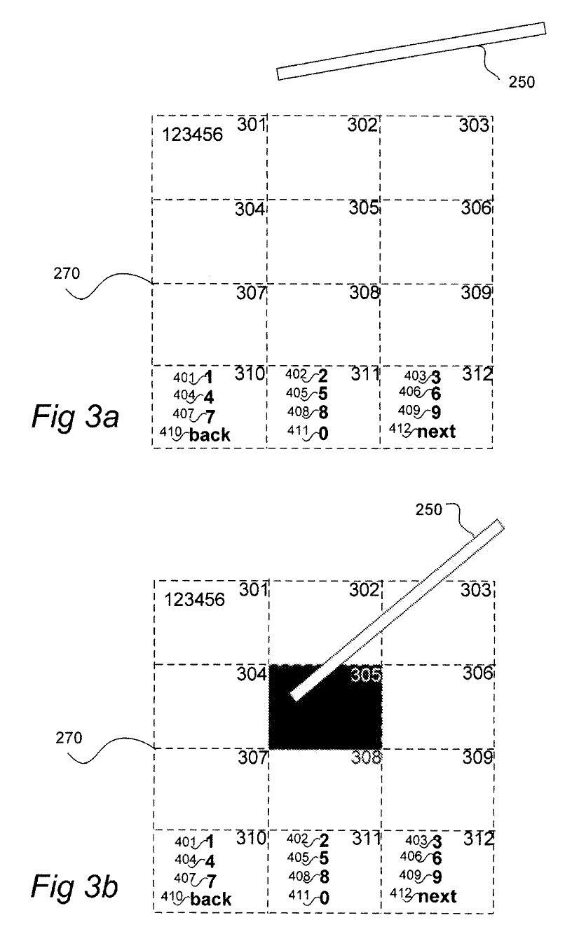

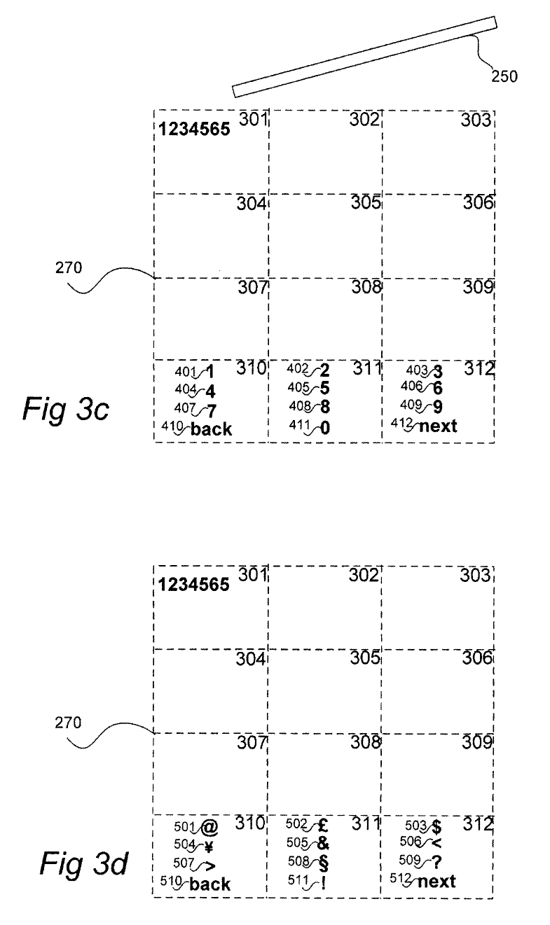

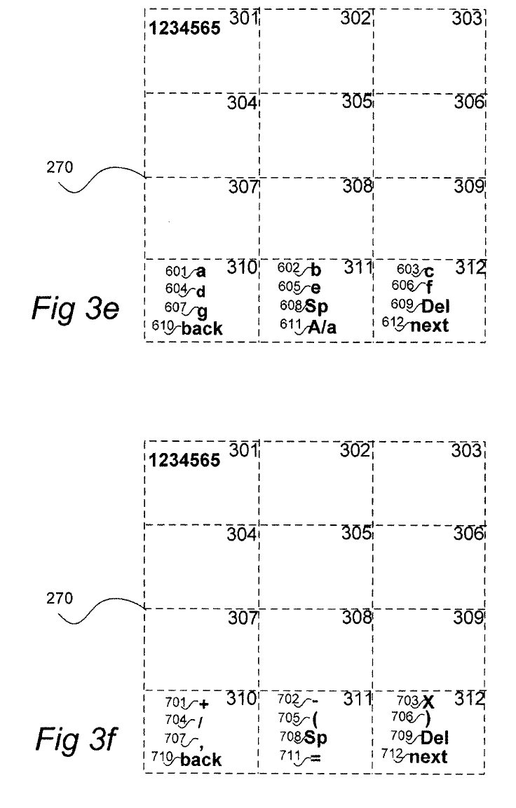

FIGS. 3a-f schematically illustrate how an object, e.g. a graphical character, can be entered into the mobile terminal according to one embodiment of the invention.

FIG. 3a illustrates the display area 270 of FIG. 2 in more detail displaying a first display state, or display view, of the display area 270 for entering objects from a set of objects into the mobile terminal 100 according to this exemplary embodiment of the invention. The display area 270 is divided into a plurality of individually selectable fields 301-312, which are arranged in a first matrix pattern having rows 301-302-303, 304-305-306, 307-308-309, 310-311-312 and columns 301-304-307-310, 302-305-308-311, 303-306-309-312. A plurality of objects 401-412 are presented (i.e., displayed) in the individually selectable fields 310, 311 and 312, i.e. within only one of the above-mentioned rows of the first matrix pattern, e.g. in the lowermost row denoted 310-311-312. The objects 401-412 together form a second matrix pattern constituted by rows 401-402-403, 404-405-406, 407-408-409, 410-411-412 and columns 401-404-407-410, 402-405-408-411, 403-406-409-412. As is illustrated in the figure, each of the objects may be an individual object, e.g. in the form of graphical characters “1”, “2”, “3”, etcetera.

It should be noted that, instead of presenting the plurality of objects 401-412 in the individually selectable fields 310, 311 and 312, these objects could alternatively be presented in only one of the above-mentioned columns of the first matrix pattern, e.g. in the rightmost column denoted 303-306-309-312.

As is illustrated in the figure, the first and second matrix patterns have corresponding dimensions. That is, both matrix patterns have the same number of rows and columns. In the disclosed embodiment, the first and second matrix patterns, respectively, are 4×3 matrix patterns having four rows and three columns, respectively. However, it should be appreciated that the invention is not limited to 4×3 matrix patterns. In other embodiments, the matrix patterns may have other dimensions, e.g. 3×3, 4×4 or 8×2 to name a few. The dimension of the matrix pattern is e.g. dependent on the intended use of the user interface of the mobile terminal 100 and should therefore be evaluated and tested in each specific case.

Each of the selectable fields 301-312 represent a particular object 401-412 having a position within the second matrix pattern which corresponds to the position of the individually selectable fields 301-312 within the first matrix pattern. That is, field 301 represents the character “1” denoted 401, field 304 represents the character “4” denoted 404, field 307 represents the character “7” denoted 407, etcetera. Hence, the selectable fields 301-312 may be said to be spatially mapped to the selectable objects 401-412.

Turning now to FIG. 3b, a user may select any of the selectable fields 301-312 using e.g. the stylus 250. Upon sensing placement of the stylus 250, hereinafter referred to as “pointer”, in a position of the display area 270, the display is operatively arranged for sensing the point of placement to determine a pointer position for, in dependence of the position of the pointer, selection of the object represented by the selected field. Hence, a user may select any of the individually selectable fields 301-312 using e.g. the stylus 250 for entering a selected object into the mobile terminal and causing the display to display the selected object. For example, if the user wants to choose numeral “5” denoted 405, the user moves the pointer to the selectable field 305 having a position within the first matrix pattern 301-302-303-304-305-306-307-308-309-310-311-312 which corresponds to the position of the character “5” (denoted 405) within the second matrix pattern 401-402-403-404-405-406-407-408-409-410-411-412. That is, if the user wants to choose the “5”, the user moves the pointer to the individually selectable field 305. Once the individual object is selected, e.g. by tapping the stylus 250 on the individually selectable field of the display area 270, the chosen object can be added to a message, to enable a message to be constructed. Accordingly, this individual object may be entered into the mobile terminal.

Turning now to FIG. 3c, FIG. 3c illustrates the display area 270 in a state when the user has selected the character “5” denoted 405. Once the “5” is selected, the selected “5” is added to a message “123456” such that the message becomes “1234565”. Then, a new object can be selected in the same manner as described with reference to FIGS. 3a-c.

One or several of the objects may be an individual object, which is associated with software code. In the illustrated example, the objects “next” and “back” denoted 410 and 412, respectively, are associated with software code. In this example, the objects 410 and 412 are associated with software code to allow movement to a new second display state, which is different from the first display state. For example, if the user wants to move to a new display view displaying new objects, the user moves the pointer to the selectable field 312 having a position within the first matrix pattern which corresponds to the position of the object “next” (denoted 412) within the second matrix pattern. That is, if the user wants to choose a new display view having different selectable objects, the user moves the pointer to the individually selectable field 312. Once the individual object “next” is selected (e.g. by tapping the stylus 250 on the selectable field 312 of the display area 270), a controller (not shown) of the mobile terminal is arranged to invoke the software code associated with the “next” object 412 to allow movement to a new display view, such as for example the display view with extra characters 501-512 e.g. “@”, “<”, “>”, “§”, “$”, “&” “£”, “¥” shown in FIG. 3d. From this display view, or display state, the user may select one or several of the extra objects for entry into the mobile terminal 100 in the same manner as described above with reference to FIGS 3a-c. If the user wants to return to the previous display view displaying the objects 401-412, the user simply moves the pointer to the selectable field 310 having a position within the first matrix pattern which corresponds to the position of the object “back” (denoted 510) within the second matrix pattern. That is, if the user wants to return to the previous display view, the user moves the pointer to the individually selectable field 310 and taps it with the stylus 250. Once the individual object “back” is selected, a controller (not shown) of the mobile terminal is arranged to invoke the software code associated with the “back” object 412 to allow reverse movement to the previous display view or display state, showing objects 401-412, i.e. “1”, “2”, “3”, etc.

It is possible to include as many display states, or display views, as necessary for covering all conceivable objects that are intended for use when operating the mobile terminal 100. Referring to FIGS. 3e-f, these figures illustrate two illustrative examples of display views with extra selectable objects. In FIG. 3e, the objects 601-607 are individual graphical letters a-g. Also, there is an object “Sp” denoted 508 for allowing entering of a space in a message to be entered. Furthermore, there is an object “Del” denoted 509 for deletion of a previously selected object. Additionally, there is illustrated an object “A/a” denoted 511 for allowing switching between small and capital letters. Again, the objects “back” and “next” denoted 610 and 612, respectively, are used for allowing reverse and forward movement between different display states or views. FIG. 3e is only exemplary and it should be noted that there could be provided as many display states, or display views, as necessary for covering e.g. the whole Latin alphabet. Finally, FIG. 3e illustrates yet another exemplary view with extra objects 701-712.

The various display states, or display views, may e.g. include Latin characters, upper case characters, lower case characters, Arabic numerals, punctuation symbols, Cyrillic characters, Chinese characters, Japanese Kanji symbols, Japanese Hiragana characters and Japanese Katakana characters, user-defined symbols, etc. As described above, by utilizing the “next” and “back” objects, respectively, it is possible to navigate backward and forward to the different display states, or display views, for selection of a desired individual object from the different display views.

From the above discussion, it should be realized that a novel and alternative way of entering objects, such as graphical characters, into a mobile terminal is provided. Only a minor part of the display screen area of the display of the mobile terminal need be used for displaying of the selectable objects. In the example described above with a 4×3 matrix patterns, only 25 percent of the total display area 270 is needed for presenting the selectable objects 401-412, 501-512, 601-612, 701-712 whereas the remaining 75 percent of the display screen area can be used for presenting the selected objects in a text message. Hence, an improved usage of the available display screen area 270 of the display of the mobile terminal 100 can be provided. Furthermore, it has turned out during testing that the navigation using between different display states, or display views, allows for a user-friendly and intuitive way of entering objects into the mobile terminal 100. In some embodiments, the remaining display area could additionally or alternatively be utilized to present other input objects, present a map, a route planning, a running application or another media, to name a few examples.

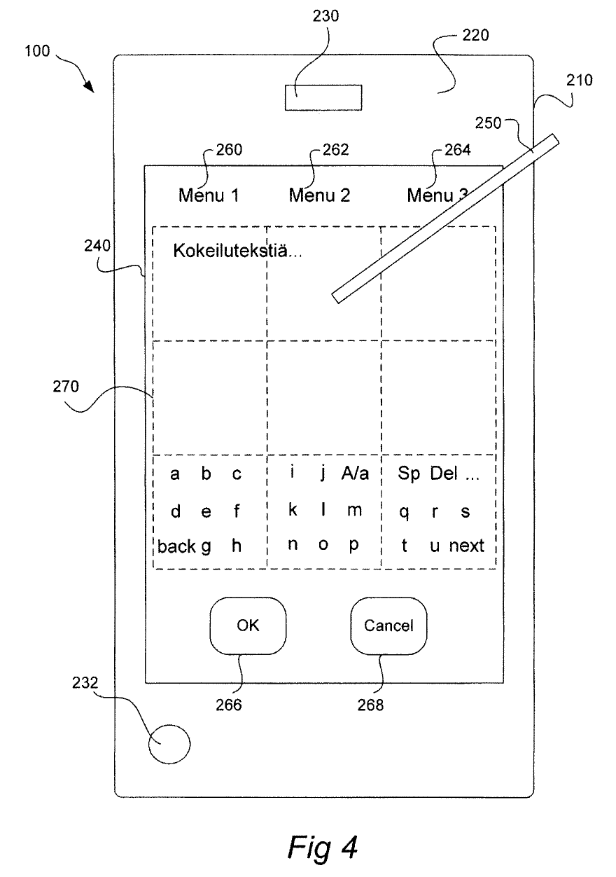

FIG. 4 illustrates another exemplary embodiment of the mobile terminal 100 of FIG. 1 in more detail. For ease of understanding, the exemplary embodiment will be described with reference to a mobile terminal 100 comprising a touch-sensitive display 240. A stylus 250 and/or a user's finger (not shown) is used for providing user input to the mobile terminal 100 by performing operations on the touch-sensitive display 240 of the mobile terminal 100. Again, it is to be noted that the present invention is not limited to mobile terminals 100 having a stylus-operated user interface as is illustrated in FIG. 4. Other embodiments of the invention could e.g. be applied in mobile terminals 100′, 100″ (see FIG. 1) having joystick-operated user interfaces or with keypad-operated user interfaces for entering information as well as operational commands.

The mobile terminal 100 comprises a housing 210. A front surface 220 of the mobile terminal 100 comprises a touch-sensitive display 240. The touch-sensitive display constitutes a user interface, which is not only an output device for presenting visual information to the user, but also an input device. In more particular, by pointing, tapping or dragging the stylus 250 on the touch-sensitive display the user may use the stylus 250 to control the user interface of the mobile terminal. As can be seen, the display 240 may comprise a display area denoted 270. In addition, the front surface 220 may comprise a speaker 230 and a microphone 232. Furthermore, the display 240 may optionally additionally include different menus 260, 262, 264 and their respective menu options and one or several selectable elements such as icons or click buttons 266, 268, etc.

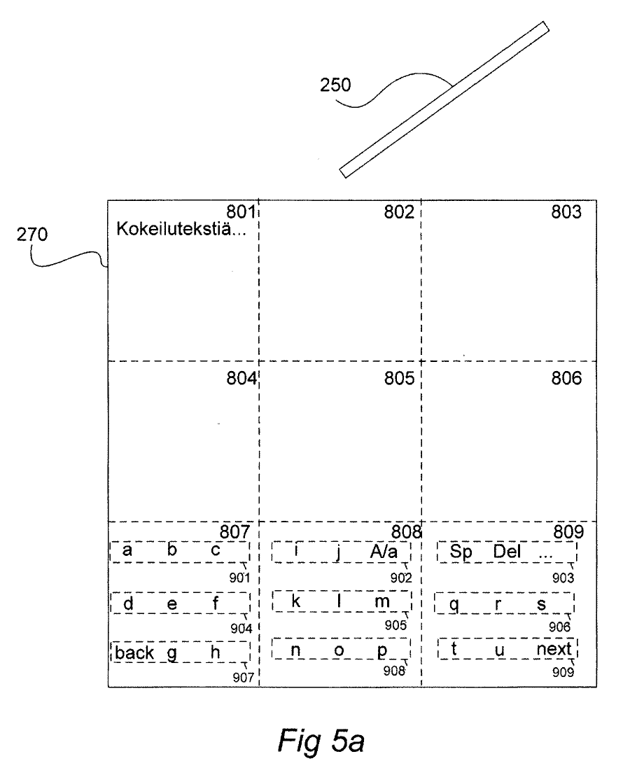

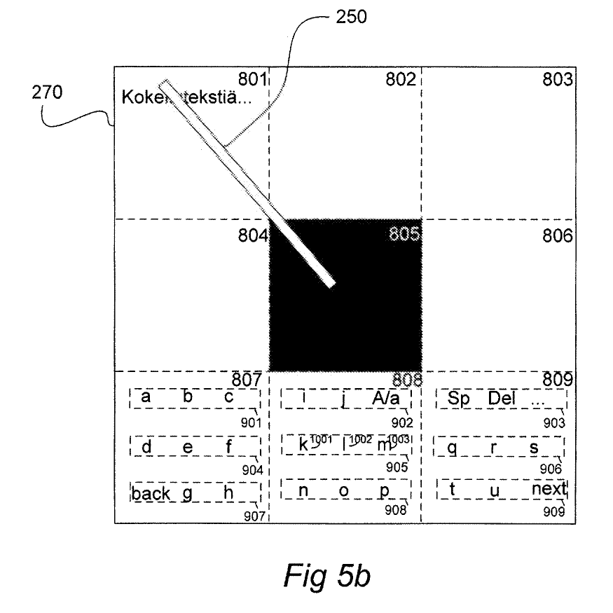

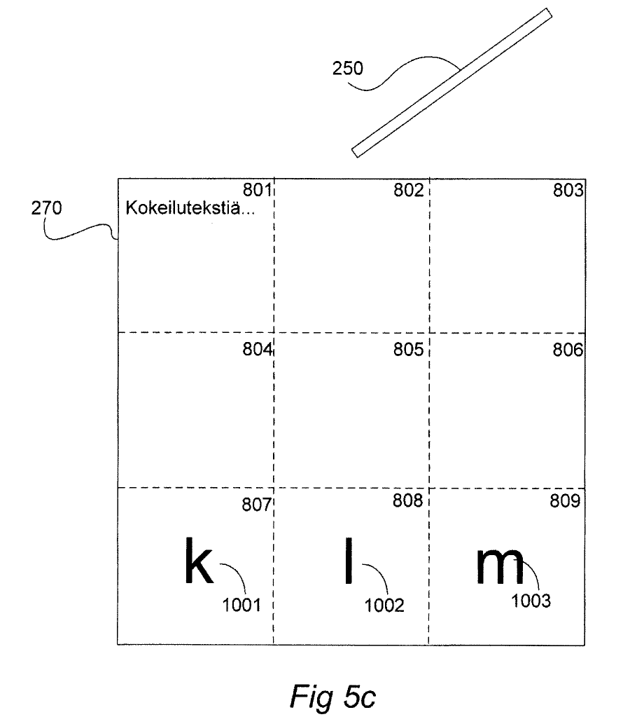

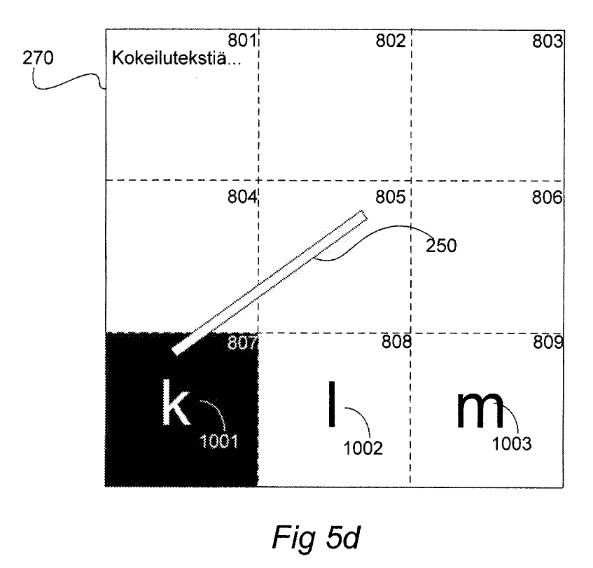

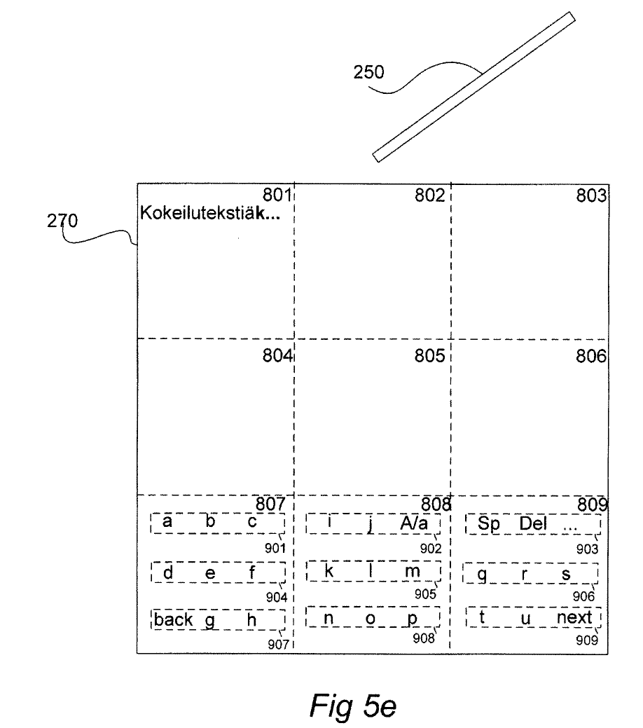

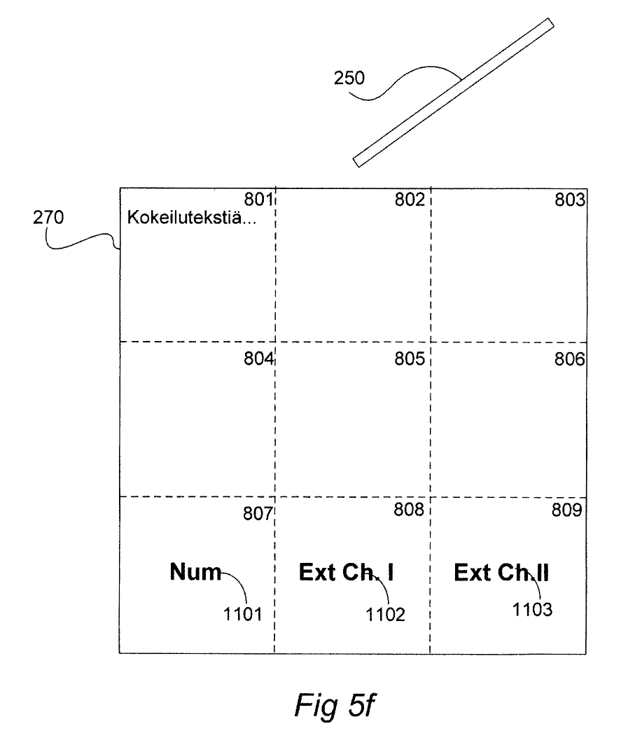

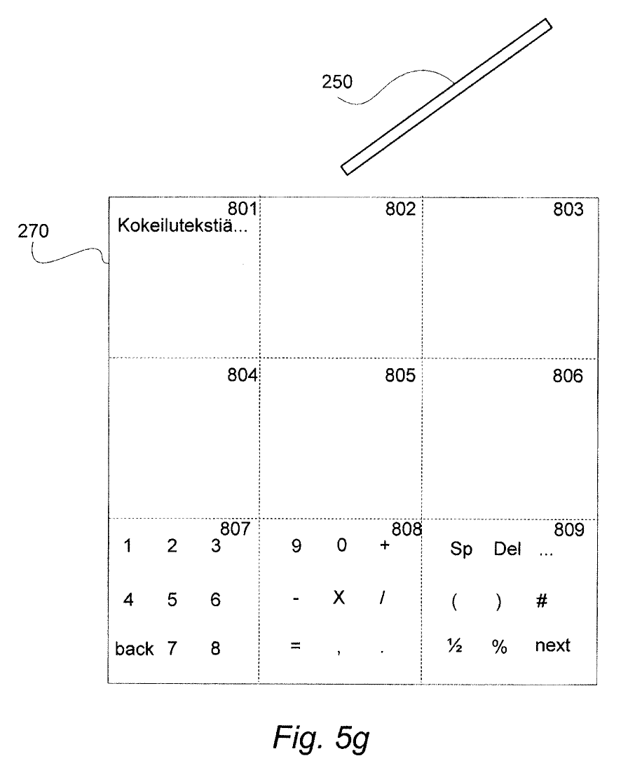

FIGS. 5a-h schematically illustrate how an object, e.g. a graphical character, can be entered into the mobile terminal according to an embodiment of the invention.

FIG. 5a illustrates the display area 270 of FIG. 4 in more detail displaying a first display state, or display view, of the display area 270 for entering objects from a set of objects into the mobile terminal 100 according to an embodiment of the invention. The display area 270 is divided into a plurality of individually selectable fields 801-809, which are arranged in a first matrix pattern having rows 801-802-803, 804-805-806, 807-808-809 and columns 801-804-807, 802-805-808, 803-806-809. A plurality of subset of objects 901-909 are presented (i.e. displayed) in the individually selectable fields 807, 808 and 809, i.e. within only one of the above-mentioned rows of the first matrix pattern, e.g. in the lowermost row denoted 807-808-809. In this way, only a minor part of the display area 270 need be used for presenting the selectable subset of objects 901-909. In this example with a 3*3 matrix pattern, only one third of the total display area 270 is needed for presenting the selectable subset of objects 901-909, whereas the remaining two thirds of the display area 270 can be used for presenting a text message such as the illustrated text message “Kokeilutekstiä”. It should, however, be noted that, instead of presenting the plurality of objects 901-909 in the individually selectable fields 807, 808 and 809, these objects could alternatively be presented in only one of the above-mentioned columns of the first matrix pattern, e.g. in the leftmost column denoted 801-804-807.

The subsets of objects 901-909 together form a second matrix pattern constituted by rows 901-902-903; 904-905-906; 907-908-909 and columns 901-904-907; 902-905-908; 903-906-909. Furthermore, as is illustrated in the figure, each of the subset of objects comprises a plurality of individual objects, e.g. in the form of graphical characters “a b c”, “d e f”, “k l m”, etcetera. In the disclosed example, in each of the subsets 901-909 the plurality of individual objects are arranged in rows, e.g. “a-b-c”, “d-e-f”, “k-l-m”, etcetera.

As is illustrated in the figure, the first and second matrix patterns have corresponding dimensions. That is, both matrix patterns have the same number of rows and columns. In the disclosed embodiment, the first and second matrix patterns, respectively, are 3×3 matrix patterns having three rows and three columns, respectively. However, it should be appreciated that the invention is not limited to 3×3 matrix patterns. In other embodiments, the matrix patterns may have other dimensions, e.g. 3×4, 4×4 or 8×2 to name a few. The dimension of the matrix pattern is e.g. dependent on the intended use of the user interface of the mobile terminal 100 and should therefore be evaluated and tested in each specific case.

Each of the selectable fields 801-809 represent a particular subset of objects 901-909 having a position within the second matrix pattern which corresponds to the position of the individually selectable fields 801-809 within the first matrix pattern. That is, field 801 represents the subset of objects “a-b-c” denoted 901, field 804 represents the subset of objects “d-e-f” denoted 904, field 807 represents the subset of objects “next-g-h” denoted 907, etcetera. Accordingly, the selectable fields 801-809 may be said to be spatially mapped to the selectable subsets of objects.

Turning now to FIG. 5b, a user may select any of the selectable fields 801-809 using e.g. the stylus 250. Upon sensing placement of the stylus 250, herein after referred to as “pointer”, in a position of the display area 270, the display is operatively arranged for sensing the point of placement to determine a pointer position and in dependence of the position of the pointer causing the display to display a second display state. The input device is operatively arranged to allow movement of the pointer to either of the individually selectable fields 801-809 through the user moving the pointer to the field representing the desired subset of objects. For example, if the user wants to choose any of the individual objects in the form of characters “k”, “l” or “m” in the subset denoted 905, the user moves the pointer to the field of the first matrix pattern 801-809 having a position which corresponds to the position of the subset 905 within the second matrix pattern 901-909, namely field 805. When this selection has been performed, the display 240 is operatively arranged to alternate to a new, second display state or display view. which is illustrated in FIG. 5c.

FIG. 5c illustrates the display area 270 of the second display state when the user has selected the subset denoted 905 as described above. In this state, the display 270 is operatively arranged to display, in the row 807-808-809 in which all the plurality of subset of objects 901-909 were previously displayed in the first display state, a row of individual objects 1001-1002-1003 corresponding to the row of individual objects 1001-1002-1003 of the selected subset of objects 905. Thus, in each selectable field 807, 808, 809 of the row 807-808-809, an individual object 1001, 1002 and 1003, respectively, is presented (i.e. displayed). Each of the individually selectable fields 807, 808, 809 of the row 807-808-809 of the first matrix pattern now represents a particular individual object 1001, 1002, 1003 having a position within the row of the selected subset of objects 905 which corresponds to the position of the individually selectable fields 807, 808, 809 within the row denoted 807-808-809 of the first matrix pattern.

Turning now to FIG. 5d, a user may select any of the selectable fields 807-809 using e.g. the stylus 250. It should be noted that, in contrast to the first display state, in the second display state the user may only select any one of the fields 807-809, that is the selectable fields arranged in the row 807-808-809. For example, if the user wants to choose character “k” denoted 1001, the user moves the pointer to the field of the row 807-808-809 having a position within this row which corresponds to the position of the “k” within the selected subset 905. That is, if the user wants to choose the “k”, the user moves the pointer to the individually selectable field 807. Once the individual object is selected the chosen object can be added to a text message, to enable a text message to be constructed. Accordingly, this individual object can be entered into the mobile terminal.

FIG. 5e illustrates the display area 270 in a state when the user has selected the character “k” denoted 801. Once the “m” is selected, the selected “k” is added to a text message “Kokeilutekstiä” such that the text message becomes “Kokeilutekstiäk”. Furthermore, the display is operatively arranged to return to the initial first display state thereby allowing the user to continue entering objects into the terminal in the same manner as has described above with reference to FIGS. 5a-e.

One or several of the individual objects within the subsets of objects may be an individual object, which is associated with software code. In the illustrated example, the individual object “ . . . ” is comprised in the subsets of objects denoted 903. This individual object “ . . . ” is associated with software code to allow movement to a new third display state, which is different from the first and second display states. For example, if the user wants to move to a new display view displaying new or extra objects, the user operates in the manner described above with reference to FIGS. 5a-e. That is, in a first step the user moves the pointer to the selectable field 803 having a position within the first matrix pattern which corresponds to the position of the subset of objects “Sp-Del- . . . ” (denoted 903) within the second matrix pattern and, subsequently in a second step, the user moves the pointer to the field of the row 807-808-809 having a position within this row which corresponds to the position of the “ . . . ” within the selected subset 903. That is, if the user wants to choose the “ . . . ”, the user moves the pointer to the individually selectable field 809. Once the user has selected “ . . . ”, a controller (not shown) of the mobile terminal is arranged to invoke the software code associated with the individual object “ . . . ” to allow movement to a new display state or display view, e.g. that illustrated in FIG. 5f.

FIG. 5f shows an example of a display view that can be presented once the user has selected the individual object “ . . . ” as described above. From this display view, or display state, the user may select one or several of the extra selections “Num”, “Ext Ch I”, “Ext Ch II” denoted 1101-1103. By moving the pointer to the selectable field 807, the user may select “Num” and thus enter a new display state, or display view, showing various numerals and other individual objects for selection, e.g. as illustrated in FIG. 5g. By moving the pointer to the selectable field 808, the user may select “Ext Ch I” and thus enter a new display state, or display view, showing various extra characters and other individual objects for selection, e.g. as illustrated in FIG. 5h. Similarly, the user may select “Ext Ch II” to enter yet another display state (not shown), or display view, including additional extra characters and other individual objects for selection.

It is possible to include as many display states, or display views, as necessary for covering all conceivable objects, e.g. in the form of characters, that are intended for use when operating the mobile terminal 100. In the various illustrated display states, the objects “back” and “next”, respectively, can be used for allowing reverse and forward movement between the different available display states or view in a similar manner as was described with reference to the embodiment described in connection with FIGS. 3a-f. Additionally, there is illustrated an object “A/a” for allowing switching between small and capital letters. Also, there is an object “Sp” for allowing entering of a space in a message to be entered. Furthermore, there is an object “Del” for allowing deletion of a previously selected, and thus entered, object.

The various display states, or display views, may e.g. include Latin characters, upper case characters, lower case characters, Arabic numerals, punctuation symbols, Cyrillic characters, Chinese characters, Japanese Kanji symbols, Japanese Hiragana characters and Japanese Katakana characters, user-defined symbols, etc. As described above, by utilizing the “next” and “back” objects, respectively, it is possible to navigate backward and forward to the different display states, or display views, for selection of an individual object from the different display views.

From the above discussion, it should be realized that a novel and alternative way of entering objects, such as graphical characters, into a mobile terminal is provided. Only a minor part of the display screen area of the display of the mobile terminal 100 need be used for displaying of the selectable objects. In the example described above with a 3×3 matrix patterns, only about 33 percent of the total display area 270 is needed for presenting the selectable objects whereas the remaining 67 percent of the display screen area can be used for presenting the selected objects in a text message. Hence, an improved usage of the available display screen area 270 of the display of the mobile terminal 100 can be provided. Furthermore, it has turned out during testing that the navigation using between different display states, or display views, provides a user-friendly and intuitive way of entering objects into the mobile terminal 100.

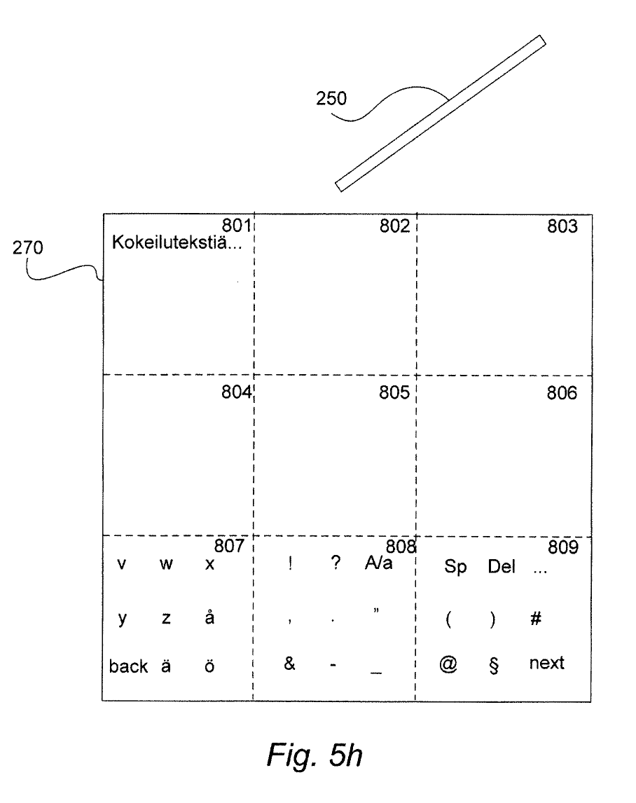

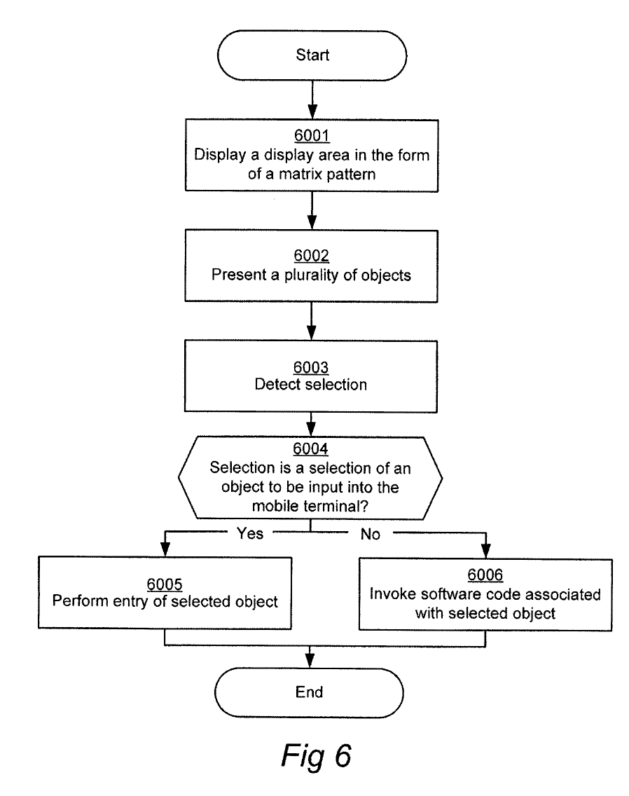

FIG. 6 is a flow chart illustrating a method according to an exemplary embodiment executable in the mobile terminal 100 of FIG. 2.

In an initial display step 6001, a display area 270, which is divided into a plurality of individually selectable fields 301-312 that are arranged in a first matrix pattern, is displayed on a display of the mobile terminal 100.

In a presentation step 6002, a plurality of objects 401-412 are presented within each of the individually selectable fields 310, 311, 312 of only one of the rows 310-311-312 (or, in an alternative embodiment, only one column) of the first matrix pattern. The plurality of objects 401-412 are arranged in such way that all the objects 401-412 together form a second matrix pattern, wherein each of the individually selectable fields 301-312 represent a particular object having a position within the second matrix pattern which corresponds to the position of the individually selectable field within the first matrix pattern.

In a detect user input selection step 6003, it is detected that a selection has been made of a desired object represented by the selected field 301-312.

In a conditional selection step 6004, it is determined if the selection detected in the previous step is a selection of an object, e.g. a graphical character, to be input into the mobile terminal 100 or if it is a selection of an object having software code associated with it.

If the selected object is an object to be input into the mobile terminal 100, the procedure continues to an object entry step 6005. Otherwise, the object is associated with software code and the procedure continues to a invoke software code step 6006.

In the entry step 6005, the object is entered into the mobile terminal.

In the invoke software code step 6006, the software code associated with the selected object is invoked by the mobile terminal 100. For example, the invoking of the software code may involve invoking software code for allowing movement between different display views presenting different objects such as Latin characters, upper case characters, lower case characters, Arabic numerals, punctuation symbols, Cyrillic characters, Chinese characters, Japanese Kanji symbols, Japanese Hiragana characters and Japanese Katakana characters, user-defined symbols, etc.

The method described with reference to FIG. 6 may be executed by computer program code means to make an electronic device having computer capabilities (e.g. , the mobile terminal 100) execute the method when the computer program means is run by the electronic device. The computer program means may be embodied on a computer readable medium, such as a memory.

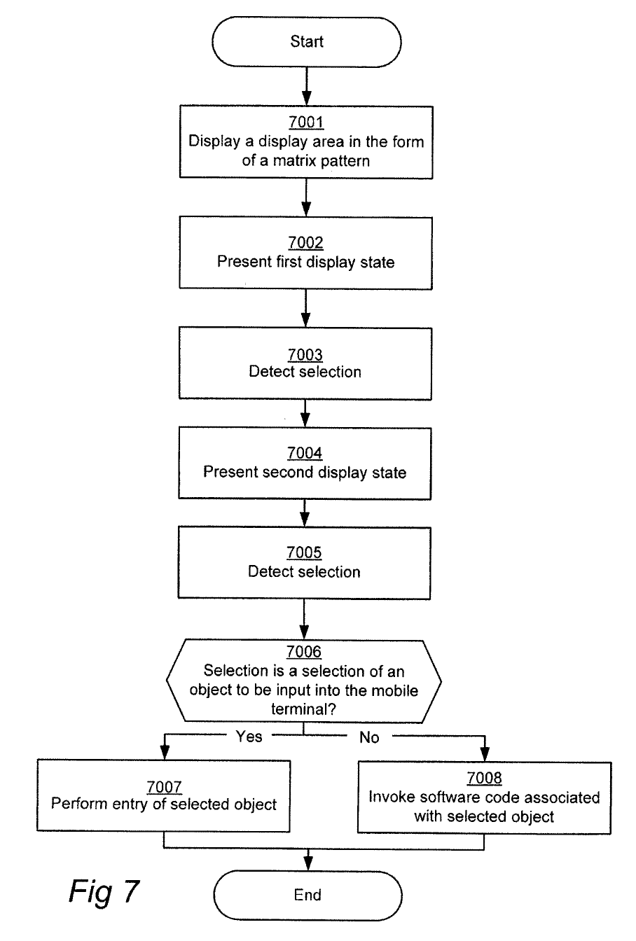

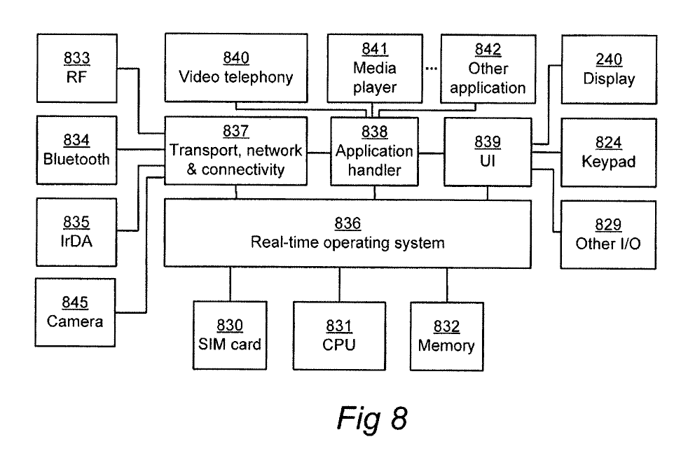

FIG. 7 is a flow chart illustrating a method according to another exemplary embodiment executable in the mobile terminal 100 of FIG. 4.

In an initial display step 7001, a display area 270, which is divided into a plurality of individually selectable fields 801-809 that are arranged in a first matrix pattern, is displayed on a display of the mobile terminal 100.

In a first display state presentation step 7002, a plurality of subset of individual objects 901-909 are presented within each of the individually selectable fields 807, 808, 809 of only one of the rows 807-808-809 (or, in an alternative embodiment, one column) of the first matrix pattern.

In a detect user input selection step 7003, it is detected that a selection has been made of a desired object represented by the selected field 801-809.

In response thereto and in a second display state presentation step 7004, an individual object is presented, within each of the individually selectable fields of the above-mentioned row 807-808-809 and such that all the individual objects of the selected subset of individual objects together form, within the 807-808-809 row, a row corresponding to the row of the selected subset of individual objects, wherein each of the individually selectable fields of the row 807-808-809 of the first matrix pattern represents a particular individual object having a position within the row of the selected subset of individual objects which corresponds to the position of the individually selectable field within the row 807-808-809.

In a detect user input selection step 7005, it is detected that a selection has been made of a desired individual object represented by the selected field 807-809.

In a conditional selection step 7006, it is determined if the selection detected in the previous step is a selection of an object, e.g. a graphical character, to be input into the mobile terminal 100 or if it is a selection of an object having software code associated with it.

If the selected object is an object to be input into the mobile terminal 100, the procedure continues to an object entry step 7007. Otherwise, the object is associated with software code and the procedure continues to a invoke software code step 7008.

In the entry step 7007, the object is entered into the mobile terminal.

In the invoke software code step 7008, the software code associated with the selected object is invoked by the mobile terminal 100. For example, the invoking of the software code may involve invoking software code for allowing movement between different display views presenting different objects such as Latin characters, upper case characters, lower case characters, Arabic numerals, punctuation symbols, Cyrillic characters, Chinese characters, Japanese Kanji symbols, Japanese Hiragana characters and Japanese Katakana characters, user-defined symbols, etc.

The method described with reference to FIG. 7 may be executed by computer program code means to make an electronic device having computer capabilities (e.g. , the mobile terminal 100) execute the method when the computer program means is run by the electronic device. The computer program means may be embodied on a computer readable medium, such as a memory.

Finally, a possible internal structure of the mobile terminal 100 will be described. A controller 831 may be responsible for the overall operation of the mobile terminal 100 and may preferably be implemented by any commercially available CPU (“Central Processing Unit”), DSP (“Digital Signal Processor”) or any other electronic programmable logic device. The controller 831 may have associated electronic memory 832 such as RAM memory, ROM memory, EEPROM memory, flash memory, hard drive, optical storage or any combination thereof. The memory 832 may be used for various purposes by the controller 831, one of them being for storing data and program instructions for various software in the mobile terminal 100. The software may include a real-time operating system 836, drivers for a user interface (UI) 839, an application handler 838 as well as various applications. The applications may include a messaging application 840, an alarm application 841, as well as various other applications 842, such as applications for voice calling, video calling, web browsing, media player, document reading and/or document editing, an instant messaging application, a phone book application, a calendar application, a control panel application, one or more video games, a notepad application, etc.

The UI 839 may also include one or more hardware controllers, which together with the UI drivers may cooperate with the display 240, a keypad 824, as well as various other I/O devices 829 such as microphone, speaker, vibrator, ring tone generator, LED indicator, etc. As is commonly known, the user may operate the mobile terminal 100 through the UI interface thus formed.

The software may also include various modules, protocol stacks, drivers, etc., which are commonly designated as 837 and which may provide communication services (such as transport, network and connectivity) for an RF interface 833, and optionally a Bluetooth interface 834 and/or an IrDA interface 835 for local connectivity. Optionally, a camera 845 may be provided. The RF interface 833 comprises an internal or external antenna as well as appropriate radio circuitry for establishing and maintaining a wireless link to a base station (e.g., the link 102 and base station 104 in FIG. 1). As is well known to a person skilled in the art, the radio circuitry may comprise a series of analogue and digital electronic components, together forming a radio receiver and transmitter. These components may include, inter alia, band pass filters, amplifiers, mixers, local oscillators, low pass filters, AD/DA converters, etc.

The mobile terminal 100 may also have a SIM card 830 and an associated reader. As is commonly known, the SIM card 830 may comprise a processor as well as local work and data memory.

Although the above-disclosed embodiments have been described with reference to a mobile terminal in the form of a mobile phone, it should be appreciated that the invention is not limited to mobile phones. Rather, the invention may be applied any type of portable apparatus, including pocket computers, portable mp3-players, portable gaming devices, cameras, lap-top computers, desktop computers, electronic organizers such as PDA's etc.

The invention has mainly been described above with reference to certain embodiments. However, as is readily appreciated by a person skilled in the art, other embodiments than the ones disclosed above are equally possible within the scope of the invention, as defined by the appended patent claims.

What is claimed is:

1. A method for entering an object from a set of objects into a mobile terminal, the method comprising:
displaying, on a display of the mobile terminal, a display area that is divided into a plurality of individually selectable fields that are arranged in a first matrix pattern having rows and columns;
presenting in a first display state, within each of the individually selectable fields of only one of the rows or columns of the first matrix pattern, a plurality of objects such that all the objects together form a second matrix pattern having rows and columns, wherein each of the individually selectable fields represent a particular object having a position within the second matrix pattern which corresponds to the position of the individually selectable field within the first matrix pattern;
moving a pointer to either of the individually selectable fields for thereby selecting the object represented by the selected field.

2. The method according to claim 1, further comprising performing an entry into the mobile terminal of the selected object.

3. The method according to claim 2, wherein the first matrix pattern is a m×n matrix with m number of rows and n number columns and, likewise, the second matrix pattern is a m×n matrix with m number of rows and n number columns, and wherein m and n are integers.

4. The method according to claim 2, wherein the object is a graphical character.

5. The method according to claim 1, wherein the object is associated with software code and the method further comprises invoking the software code of the selected object associated with the software code.

6. The method according to claim 5, wherein said invoking software code involves invoking software code for allowing movement to a second display state, which is different from the first display state.

7. The method according to claim 1, wherein the object is a subset of individual objects and the step of moving comprises moving the pointer to either of the individually selectable fields for thereby selecting the subset of individual objects represented by the selected field, and the method further comprising, in response thereto:
presenting in a second display state, within each of the individually selectable fields of said only one of said rows or columns of the first matrix pattern, an individual object such that all the individual objects of the selected subset of individual objects together form, within said only one of said rows or columns of the first matrix pattern, a row or column corresponding to the row or column of the selected subset of individual objects, wherein each of the individually selectable fields of said only one of said rows or columns of the first matrix pattern represent a particular individual object having a position within the row or column of the selected subset of individual objects which corresponds to the position of the individually selectable field within the said only one of said rows or columns of the first matrix pattern; and
moving a pointer to either of the individually selectable fields of said only one of said rows or columns of the first matrix pattern for selection of the individual object represented by the selected field.

8. The method according to claim 7, further comprising:
performing an entry into the mobile terminal of the selected individual object.

9. The method according to claim 8, wherein the first matrix pattern is a m×n matrix with m number of rows and n number columns and, likewise, the second matrix pattern is a m×n matrix with m number of rows and n number columns, and wherein m and n are integers.

10. The method according to claim 7, wherein the set of individual objects is a set of graphical characters arranged in a row or column.

11. The method according to claim 10, wherein an individual object is an individual graphical character.

12. The method according to claim 7, wherein an individual object is associated with software code and the method further comprises invoking the software code of the selected individual object associated with the software code.

13. The method according to claim 12, wherein said invoking software code involves invoking software code for allowing movement to a third display state, which is different from the first and second display states.

14. A computer program product comprising software instructions that, when executed in a controller of a mobile terminal, performs the method according to claim 1.

15. A mobile terminal for entering an object from a set of objects into the mobile terminal, comprising:
a display operative to display, in a first display state, a display area that is divided into a plurality of individually selectable fields that are arranged in a first matrix pattern having rows and columns, and further operative to display, within each of the individually selectable fields of only one of the rows or columns of the first matrix pattern, a plurality of objects such that all the objects together form a second matrix pattern having rows and columns, wherein each of the individually selectable fields represent a particular object having a position within the second matrix pattern which corresponds to the
position of the individually selectable field within the first matrix pattern; and an input device operative to determine a position of a pointer with respect to the plurality of individually selectable fields, wherein the pointer is moveable to either of the individually selectable fields for selection of the object represented by the selected field.

16. The mobile terminal according to claim 15, wherein the input device is configured to perform an entry into the mobile terminal of the selected object.

17. The mobile terminal according to claim 16, wherein the first matrix pattern is a m×n matrix with m number of rows and n number columns and, likewise, the second matrix pattern is a m×n matrix with m number of rows and n number columns, and wherein m and n are integers.

18. The mobile terminal according to claim 15, wherein the object is a graphical character.

19. The mobile terminal according to claim 15, wherein the object is associated with software code and a controller of the mobile terminal is operative to invoke the software code of the selected object associated with the software code.

20. The mobile terminal according to claim 19, wherein said controller of the mobile terminal is configured to invoke said invoking software code for allowing movement to a second display state, which is different from the first display state.

21. The mobile terminal according to claim 15, wherein the object is a subset of individual objects, and wherein
the input device is further configured to determine a position of a pointer with respect to the plurality of individually selectable fields, for in dependence of the position of the pointer causing the display to display in a second display state, within each of the individually selectable fields of said only one of said rows or columns of the first matrix pattern, an individual object of the selected subset of individual objects such that all the individual objects of the selected subset of individual objects together form, within said only one of said rows or columns of the first matrix pattern, a row or column corresponding to the row or column of the selected subset of individual objects, wherein each of the individually selectable fields of said only one of said rows or columns of the first matrix pattern represent a particular individual object having a position within the row or column of the selected subset of individual objects which corresponds to the position of the individually selectable fields within the said only one of said rows or columns of the first matrix pattern; and wherein
the pointer is further moveable to a either of the individually selectable fields for selection of the individual object represented by the selected field.

22. The mobile terminal according to claim 21, wherein the input device is configured to perform an entry into the mobile terminal of the selected individual object.

23. The mobile terminal according to claim 22, wherein the first matrix pattern is a m×n matrix with m number of rows and n number columns and, likewise, the second matrix pattern is a m×n matrix with m number of rows and n number columns, and wherein m and n are integers.

24. The mobile terminal according to claim 22, wherein the set of individual objects is a set of graphical characters arranged in a row or column.

25. The mobile terminal according to claim 24, wherein an individual object is an individual graphical character.

26. The mobile terminal according to claim 21, wherein an individual object is associated with software code and a controller of the mobile terminal is configured to invoke the software code of the selected object associated with the software code.

27. The mobile terminal according to claim 26, wherein said controller of the mobile terminal is configured to invoke said invoking software code for allowing movement to a third display state, which is different from the first and second display states.

28. A user interface for entering an object from a set of objects into a mobile terminal, comprising:
a display configured to display, in a first display state, a display area that is divided into a plurality of individually selectable fields that are arranged in a first matrix pattern having rows and columns, and further configured to display, within each of the individually selectable fields of only one of the rows or columns of the first matrix pattern, a plurality of objects such that all the objects together form a second matrix pattern having rows and columns, wherein each of the individually selectable fields represent a particular object having a position within the second matrix pattern which corresponds to the position of the individually selectable field within the first matrix pattern; and
an input device configured to determine a position of a pointer with respect to the plurality of individually selectable fields, wherein the pointer is moveable to either of the individually selectable fields for selection of the object represented by the selected field.

29. A user interface for entering an object from a set of objects into a mobile terminal, comprising:
a display configured to display, in a first display state, a display area that is divided into a plurality of individually selectable fields that are arranged in a first matrix pattern having rows and columns, and further operative to display, within each of the individually selectable fields of only one of the rows or columns of the first matrix pattern, a plurality of subset of objects such that all the subsets of objects together form a second matrix pattern having rows and columns, wherein each of the individually selectable fields represent a particular subset of objects having a position within the second matrix pattern which corresponds to the position of the individually selectable field within the first matrix pattern; and
an input device configured to determine a position of a pointer with respect to the plurality of individually selectable fields, for in dependence of the position of the pointer causing the display to display in a second display state, within each of the individually selectable fields of said only one of said rows or columns of the first matrix pattern, an individual object such that all the individual objects of the selected subset of objects together form, within said only one of said rows or columns of the first matrix pattern, a row or column corresponding to the row or column of the selected subset of objects, wherein each of the individually selectable fields of said only one of said rows or columns of the first matrix pattern represent a particular individual object having a position within the row or column of the selected subset of objects which corresponds to the position of the individually selectable fields within the said only one of said rows or columns of the first matrix pattern; and wherein
the pointer is moveable to a either of the individually selectable fields for selection of the subset of objects or individual object represented by the selected field.
